(19) United States
(12) Patent Application Publication
(10) Pub. No.: US 2025/0313096 A1
(43) Pub. Date: Oct. 9, 2025

(54) ELECTRIFIED VEHICLE FOR PROVIDING STAY MODE

(71) Applicants: Hyundai Motor Company, Seoul (KR); Kia Corporation, Seoul (KR)

(72) Inventor: Dong Su HA, Pohang-Si (KR)

(73) Assignees: Hyundai Motor Company, Seoul (KR); Kia Corporation, Seoul (KR)

(21) Appl. No.: 18/930,864

(22) Filed: Oct. 29, 2024

(30) Foreign Application Priority Data
Apr. 8, 2024 (KR) 10-2024-0047069

(51) Int. Cl. B60L 50/61; B60L 50/70; B60W 10/28; B60W 30/182; B60W 50/10; B60W 50/14

(52) U.S. Cl. CPC B60L 50/61; B60L 50/70; B60W 10/28; B60W 30/182; B60W 50/10; B60W 50/14; B60L 2240/28; B60L 2240/443; B60L 2240/486; B60L 2250/16; B60L 2260/22; B60W 2050/146; B60W 2510/0657; B60W 2510/244; B60W 2510/28; B60W 2556/10

(57) ABSTRACT

An electrified vehicle includes an electric generator that generates electrical energy using vehicle fuel, an energy storage system that stores the electrical energy generated by the electric generator, and a control unit that controls, when a vehicle state satisfies a predetermined stay mode entry condition in a vehicle-stop state, a vehicle system including the electric generator for entering and executing a stay mode. The stay mode is a mode in which a vehicle user can use vehicle energy including the electrical energy stored in the energy storage system when the vehicle user stays in the vehicle in the vehicle-stop state, and the control unit confirms, when it is necessary to secure the vehicle energy including the electrical energy in the stay mode, a vehicle user's intention to use additional energy and to control the vehicle system for securing the vehicle energy according to the vehicle user's intention.

### CROSS-REFERENCE TO RELATED APPLICATION

The present application claims priority to Korean Patent Application No. 10-2024-0047069 filed on Apr. 8, 2024, the entire contents of which is incorporated herein for all purposes by this reference.

### BACKGROUND OF THE PRESENT DISCLOSURE

### Field of the Present Disclosure

The present disclosure relates to an electrified vehicle, configured for providing quiet and comfortable roominess to a user, allowing the use of electric apparatuses without concerns about battery charging, and providing a long-term stay mode.

### Description of Related art

Recently, as the era of high oil prices continues, the demand for electrified vehicles is increasing, and the proportion of electrified vehicles among all vehicles is estimated to gradually increase in the future.

Such an electrified vehicle refers to a vehicle that utilizes an electric motor as a drive system thereof, that is, a vehicle which is driven by a motor, and includes a vehicle that utilizes a motor alone and a vehicle that utilizes a motor and an engine (Internal Combustion Engine, ICE) together.

The vehicle that utilizes the motor alone includes a battery electric vehicle (BEV) that utilizes a battery as a power source (energy source), and a fuel cell electric vehicle (FCEV) that utilizes a fuel cell as a main power source.

The vehicle that utilizes the motor and the engine together includes a hybrid electric vehicle (HEV) that can only charge a battery through its own electric generator, and a plug-in hybrid electric vehicle (PHEV) that can externally charge a battery by connecting the vehicle to an external power supply.

Among the above-mentioned electrified vehicles, those capable of charging their batteries with the external power supply are the battery electric vehicle and the plug-in hybrid electric vehicle, and those capable of charging their batteries using the fuel-using electric generator are the hybrid electric vehicle (HEV and PHEV) and the fuel cell electric vehicle.

In the case of the hybrid electric vehicle, the engine that utilizes fuel and the motor that receives the rotational power of the engine to generate power are the electric generators. In the case of the fuel cell electric vehicle, the fuel cell that utilizes hydrogen as fuel gas is the electric generator.

Among the electrified vehicles, the battery electric vehicle (BEV) is referred to as a pure electrified vehicle, but the hybrid electric vehicle (HEV and PHEV) and the fuel cell electric vehicle (FCEV) may also be referred to as electrified vehicles (xEV) in a broad sense.

In the case of the electrified vehicles, there are restrictions on market expansion due to charging infrastructure and vehicle prices, but since they may be driven with only a motor, many users are satisfied with not only quietness and indoor comfort, but also driving performance.

As the Coronavirus period passes, the life patterns of vehicle users are changing significantly. The frequency of using various electric apparatuses such as multimedia apparatuses including audio, air conditioning systems, electric appliances, and in-vehicle outlets while living inside the vehicle for a long time period is gradually increasing. Accordingly, a variety of research and development is underway to further improve the roominess of the electrified vehicles.

For example, a mode in which a vehicle is electrically connected to an external power supply and a driver utilizes power supplied from the external power supply is known. Furthermore, in the hybrid electric vehicle (HEV and PHEV) provided with a high-voltage battery, for the use of electric apparatuses such as an air conditioning system, a mode in which its own electric generator, that is, an engine which is an electric generation element of the vehicle, is idling and electric generation is performed by a motor or generator using the rotational power of the engine, is known.

Furthermore, since the fuel cell vehicle is provided with a fuel cell, which is an electric generator that utilizes hydrogen gas as fuel, and a high-voltage battery, it is possible to stay in the vehicle for a long time while using electric apparatuses such as an air conditioning system.

However, in the case of the hybrid electric vehicle, the engine may be operated to continuously supply power, and thus, there are problems such as noise, vibration, and exhaust fumes. Furthermore, in a case where the engine is left idling for a long time, problems in terms of engine durability may occur.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electrified vehicle, configured for providing quiet and comfortable roominess to a vehicle user in a vehicle stop state, allowing the use of electric apparatuses without concerns about battery charging, and providing a long-term stay mode.

In one aspect, the present disclosure provides an electrified vehicle including an electric generator configured to generate electrical energy using vehicle fuel, an energy storage system configured to store the electrical energy generated by the electric generator, and a control unit configured to control, in a case where a vehicle state satisfies a predetermined stay mode entry condition in a state in which the vehicle is stopped, a vehicle system including the electric generator for entering and executing a stay mode, in which the stay mode is a mode in which a vehicle user can use vehicle energy including the electrical energy stored in the energy storage system in a case where the vehicle user stays in the vehicle in a state in which the vehicle is parked, and the control unit is configured to confirm, in a case where it is necessary to secure the vehicle energy including the electrical energy in the stay mode, a vehicle user's intention to use additional energy and to control the vehicle system for securing the vehicle energy according to the vehicle user's intention.

In an exemplary embodiment of the present disclosure, the vehicle may be a hybrid electric vehicle provided with an engine and a motor as a drive system thereof, and the electric generator may include the engine and a hybrid starter generator which is connected to the engine for power transmission and performs power generation using rotational power of the engine.

In another exemplary embodiment of the present disclosure, the control of the vehicle system for securing the vehicle energy may be an idle charging control for blocking the power transmission between the engine and the motor by opening an engine clutch mounted between the engine and the motor and driving the engine to charge the energy storage system with electrical energy generated by the hybrid starter generator using the rotational power of the engine.

In yet another exemplary embodiment of the present disclosure, the vehicle may be a hybrid electric vehicle provided with an engine and a motor as a drive system thereof, and the electric generator may include the engine and the motor that performs power generation using rotational power transmitted from the engine.

In yet another exemplary embodiment of the present disclosure, the control of the vehicle system for securing the vehicle energy may be performed by closing an engine clutch mounted between the engine and the motor for power transmission between the engine and the motor, controlling a transmission on a motor output side to a neutral state, and driving the engine and controlling the power generation of the motor to charge the energy storage system with the electrical energy generated by the motor using the rotational power of the engine.

In still yet another exemplary embodiment of the present disclosure, the vehicle may be a fuel cell vehicle, and the electric generator may include a fuel cell that generates electrical energy using fuel gas.

In a further exemplary embodiment of the present disclosure, the predetermined stay mode entry condition may include conditions in which a vehicle gear range is P, which is a parking range, and a vehicle power is in an ACC power state.

In another further exemplary embodiment of the present disclosure, in a case where the predetermined stay mode entry condition is satisfied and the vehicle user turns on the stay mode, the control unit may perform control for entering and executing the stay mode.

In yet another further exemplary embodiment of the present disclosure, the stay mode may be a mode in which the electrical energy stored in the energy storage system is supplied to be usable in an air conditioning system, a vehicle infotainment system, an electric apparatus mounted in or connected to the vehicle, or an outlet in the vehicle.

In yet another further exemplary embodiment of the present disclosure, the electrified vehicle may further include a navigation device configured to set a destination and guide a driving route to the destination, in which the control unit performs, in a case where the vehicle arrives at the destination set in the navigation device and the predetermined stay mode entry condition is satisfied, control for entering and executing the stay mode.

In still yet another further exemplary embodiment of the present disclosure, the control unit may perform, in a case where a determination is made that the vehicle has arrived at a location within a preset distance from the set destination based on navigation information transmitted from the navigation device, control for increasing a state of charge (SOC) value of the energy storage system while the vehicle is traveling to the destination.

In a still further exemplary embodiment of the present disclosure, in a case where the vehicle arrives at the destination set in the navigation device, the control unit may check whether the destination at which the vehicle arrived is a location with a previous stay mode usage record, output, in a case where the destination is the location with the previous stay mode usage record and the predetermined stay mode entry condition is satisfied, a message for inducing and recommending ON of the stay mode through the information output device, and perform, in a case where the vehicle user selects ON of the stay mode according to the message, control for entering and executing the stay mode.

In a yet still further exemplary embodiment of the present disclosure, the control unit may perform control, in a case where the destination set in the navigation device is a location with a stay mode usage record more than a preset number of times, for increasing the state of charge of the energy storage system while the vehicle is traveling to the destination when the vehicle enters an area within a preset distance from the destination.

In a yet still further exemplary embodiment of the present disclosure, the vehicle may be a hybrid electric vehicle provided with an engine and a motor as a drive system thereof, the electric generator may include the engine and a hybrid starter generator which is connected to the engine for power transmission and perform power generation using rotational power of the engine, and the control for increasing the state of charge of the energy storage system may be performed by increasing torque of the engine to increase the amount of power generated by the electric generator and performing shift control according to a predetermined charge shift pattern for a transmission.

In a yet still further exemplary embodiment of the present disclosure, in a case where the vehicle arrives at the destination set in the navigation device, the control unit may check whether the destination at which the vehicle arrived is a location with a previous stay mode usage record, check, in a case where the destination is a location with no previous stay mode usage record and the predetermined stay mode entry condition is satisfied, whether a vehicle door is not opened and remains closed for a predetermined time period after the vehicle is stopped, output, in a case where the vehicle door remains closed for the predetermined time period, a message for inducing and recommending ON of the stay mode through the information output device, and perform, in a case where the vehicle user selects ON of the stay mode according to the message, control for entering and executing the stay mode.

In a yet still further exemplary embodiment of the present disclosure, the control unit may control an operation of a display device to display a usable time of the electrical energy stored in the energy storage system in the stay mode state.

In a yet still further exemplary embodiment of the present disclosure, the control unit may perform control, in a case where a current time and a current vehicle location match a reservation schedule and a reservation location for the day and a time slot preset by the vehicle user in a state in which the vehicle is stopped after moving, for entering and executing the stay mode in a case where the predetermined stay mode entry condition is satisfied.

Other aspects and exemplary embodiments of the present disclosure are discussed infra.

It is to be understood that the term “vehicle” or “vehicular” or other similar terms as used herein are inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, vehicles powered by both electricity and gasoline.

The methods and apparatuses of the present disclosure have other features and advantages which will be apparent from or are set forth in more detail in the accompanying drawings, which are incorporated herein, and the following Detailed Description, which together serve to explain certain principles of the present disclosure. The above and other features of the present disclosure are discussed infra.

### BRIEF DESCRIPTION OF THE DRAWINGS

FIG. 1 is a block diagram showing a system configuration of an electrified vehicle according to an exemplary embodiment of the present disclosure;

FIG. 2 is a block diagram showing control elements and operating elements that perform a control process of an electrified vehicle according to an exemplary embodiment of the present disclosure;

FIG. 3 is a diagram schematically showing a control process according to an exemplary embodiment of the present disclosure;

FIG. 4 is a flowchart showing several examples of methods for entering a stay mode according to an exemplary embodiment of the present disclosure;

FIG. 5 is a flowchart showing a stay mode entry and control process according to an exemplary embodiment of the present disclosure;

FIG. 6 is a diagram showing a message display screen for guiding entry into a stay mode according to an exemplary embodiment of the present disclosure;

FIG. 7 is a diagram showing an idle charge state according to an exemplary embodiment of the present disclosure;

FIG. 8 is a diagram showing a stay mode setting screen according to an exemplary embodiment of the present disclosure;

FIG. 9 is a diagram showing a modal dialog for asking whether to use a stay mode according to an exemplary embodiment of the present disclosure;

FIG. 10 is a flowchart showing an example in which a user determines whether to use a stay mode using display information provided through an information output device according to an exemplary embodiment of the present disclosure;

FIG. 11 is a flowchart showing another example of stay mode entry, idle charging, and EV mode execution according to an exemplary embodiment of the present disclosure;

FIG. 12 is a diagram showing a state in which a driver sets a stay mode to ON through an input device according to an exemplary embodiment of the present disclosure;

FIG. 13 is a flowchart showing driving control and battery charging control for executing a stay mode during traveling according to an exemplary embodiment of the present disclosure;

FIG. 14 is a diagram showing an example of displaying a usable battery capacity as time information on a cluster in an EV mode of a stay mode according to an exemplary embodiment of the present disclosure; and

FIG. 15 is a diagram showing an example of displaying a usable battery capacity as time information on an AVNT in an EV mode of a stay mode according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Hereinafter, reference will be made in detail to various embodiments of the present disclosure, examples of which are illustrated in the accompanying drawings and described below. While the present disclosure will be described in conjunction with exemplary embodiments of the present disclosure, it will be understood that the present description is not intended to limit the present disclosure to the exemplary embodiments of the present disclosure. On the other hand, the present disclosure is directed to cover not only the exemplary embodiments of the present disclosure, but also various alternatives, modifications, equivalents and other embodiments, within the spirit and scope of the present disclosure as defined by the appended claims.

It will be understood that, although the terms “first”, “second”, etc. may be used herein to describe various elements, these elements should not be limited by these terms. These terms are only used to distinguish one element from another. For example, a first element may be termed a second element, and similarly, a second element may be termed a first element, without departing from the scope of the exemplary embodiments of the present disclosure.

Furthermore, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other words used to describe the relationship between elements should be interpreted in a similar manner (for example, “between” and “directly between”, “adjacent” and “directly adjacent”, etc.).

Wherever possible, the same reference numbers will be used throughout the drawings to refer to the same or like parts. The terminology used herein is for describing various exemplary embodiments only and is not intended to limit exemplary embodiments of the present disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure provides an electrified vehicle including a vehicle mode for providing quiet and comfortable roominess to a vehicle user, allowing the use of various electric apparatuses without concerns about battery charging, and allowing long-term stay.

An electrified vehicle according to an exemplary embodiment of the present disclosure may be a hybrid electric vehicle (HEV, PHEV) or a fuel cell electric vehicle (FCEV), provided with its own electric generator that generates electric power using fuel together with a high-voltage battery, and a charging device for charging the battery with electric power generated by the electric generator.

In the hybrid electric vehicle, the electric generator may include an engine which is operated by fuel to generate and provide rotational power, and a motor that operates as an electric generator using the rotational power of the engine. Here, the motor may be a hybrid starter generator (HSG) or a drive motor that drives the vehicle.

In the fuel cell electric vehicle, the electric generator may include a fuel cell that generates electrical energy using hydrogen gas as fuel. Generally, a fuel cell for a vehicle refers to a fuel cell stack in which unit cells are stacked to meet a necessary output.

In the hybrid electric vehicle and the fuel cell vehicle, a charging device mounted in the vehicle may include a power converter such as an inverter for charging the high-voltage battery, which is a vehicle's energy storage system.

The present disclosure provides comfortable roominess as in a battery electric vehicle (BEV) which is a pure electric vehicle and indoor stay while allowing the use of vehicle power and electrical devices for as long as possible without concerns about battery charging, in a hybrid electric vehicle (HEV, PHEV) and a fuel cell electric vehicle (FCEV) in which a vehicle user such as a driver engages in various activities inside the vehicle or around the vehicle.

In an exemplary embodiment of the present disclosure, a vehicle mode in which a vehicle user is capable of staying indoors for a long time, that is, a vehicle mode in which the user is capable of staying in a vehicle for a long time while using electric apparatuses using electric power generated by its own electric generator, which generates the electric power using vehicle fuel, or battery power generated by the electric generator is referred to as a “stay mode”.

In an exemplary embodiment of the present disclosure, the stay mode may refer to a mode in which a vehicle user uses vehicle energy including electrical energy stored in a vehicle's energy storage system (e.g., battery) in a case where the vehicle user stays in a vehicle in a stopped state.

In the stay mode provided by the electrified vehicle according to the exemplary embodiment of the present disclosure, an air conditioning system to generate a comfortable indoor environment during parking, an infotainment system that provides integrated functions of information and entertainment, and a variety of electric apparatuses (e.g., mood lamp, room lamp, audio, display, seat heating wire, hair dryer, beam projector, electric grill) or outlets mounted in the vehicle or connected to the vehicle are configured.

Furthermore, in the stay mode, it is possible to minimize emotional dissatisfaction issues due to engine operation during stop (engine idling noise in switching from EV mode to HEV mode, etc.), and it is possible to use the vehicle as a rest area after going to work early to avoid rush hour.

According to the stay mode provided by the electrified vehicle of the exemplary embodiment, it is possible to improve vehicle fuel efficiency, reduce exhaust gas emission, and increase engine durability, compared with a general internal combustion engine (ICE) vehicle that idles for a long time.

From the standpoint of vehicle manufacturers, it is possible to make consumers recognize hybrid electric vehicles, which are still recognized as vehicles close to regular internal combustion engine (ICE) vehicles, as vehicles close to pure electrified vehicles, to thereby more efficiently and naturally adapt to recent market changes that are occurring in the transition period to electrified vehicles.

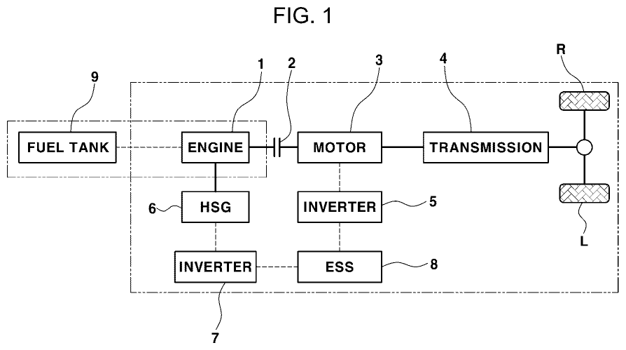

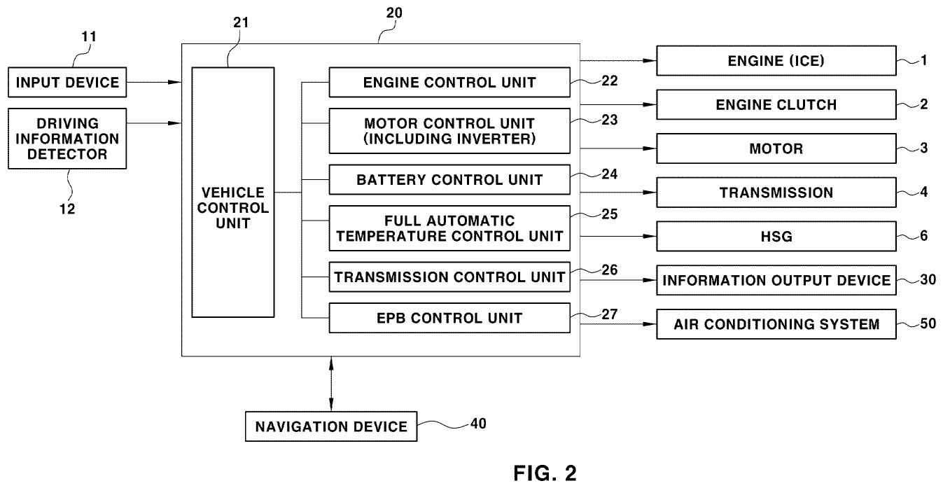

FIG. 1 is a block diagram showing a system configuration of an electrified vehicle according to an exemplary embodiment of the present disclosure, and FIG. 2 is a block diagram showing control elements and operating elements that perform a control process of an electrified vehicle according to an exemplary embodiment of the present disclosure.

FIG. 1 shows a configuration of a hybrid system including a powertrain configuration of a parallel hybrid electric vehicle. As shown in FIG. 1, the hybrid system includes an engine 1 and a motor 3, which configure a drive system for driving the vehicle, an engine clutch 2 which is located between the engine 1 and the motor 3, a transmission 4 which is connected to an output side of the motor 3 for power transmission, an inverter 5 for driving the motor 3, and an energy storage system (ESS) 8 which is connected to the motor 3 through the inverter 5 as a power source of the motor 3 for charging and discharging.

Here, the motor 3 is a drive system that drives the vehicle, which is a drive motor mounted as a vehicle drive source in a typical hybrid electric vehicle. Furthermore, the energy storage system 8 may be one or both of a battery or a capacitor.

In the following description, the battery is the energy storage system 8 which is connected to a vehicle's electric generator to enable charging and discharging through the inverter which is a charging device in the electrified vehicle according to the exemplary embodiment of the present disclosure, which may be a high-voltage battery mounted in a typical hybrid electric vehicle.

In FIG. 1, reference numeral “6” represents a separate motor, that is, a hybrid starter generator (HSG), which is connected to the engine 1 to start the engine or perform power generation using rotational power transmitted from the engine. The energy storage system 8 is also connected to the HSG 6 through the inverter 7 to enable charging and discharging.

Since the HSG 6 operates as a motor or an electric generator and is directly connected to the engine 1 to enable constant power transmission through a powertrain such as a belt and pulleys, or gears, it may also be used to control engine speed.

The engine clutch 2 is closed or opened by hydraulic pressure to allow or block power transmission between the engine 1 and the motor 3. During idle charging, which will be described later, the engine clutch 2 may block power transmission so that the rotational power of the engine is not transmitted to the motor 3. Here, the engine clutch 2 is controlled to disconnect the engine 1 and the motor 2.

In the configuration of FIG. 1, the respective inverters 5 and 7 convert direct current of the energy storage system 8 into three-phase alternating current and supply the result to the motor 3 and the HSG 6 to drive the motor 3 and the HSG 6. Conversely, in a case where the motor 3 and HSG 6 perform power generation, the respective inverters 5 and 7 convert alternating current generated by the motor 3 and HSG 6 into direct current and supply the result to the energy storage system 8.

Furthermore, the transmission 4 speed-shifts power of the motor 3 or combined power of the engine 1 and the motor 3, and transmits the result to drive wheels L and R through a driveshaft. In the electrified vehicle according to the exemplary embodiment of the present disclosure, the transmission 4 may be an automatic transmission based on a shift-by-wire (SBW) system, which is an electronic transmission system.

In the SBW system, in a case where a sensor signal generated when operating an operating device in a form of an electronic shift lever, a button, or a dial is transmitted to a transmission control unit (TCU) 26 in FIG. 2, shift control is performed according to the control signal of the transmission control unit 26. In the SBW system, a driver may easily perform a transmission operation for drive (D), reverse (R), neutral (N), and park (P) ranges using the button-type or dial-type operating device.

In FIG. 1, a fuel tank 9 stores fuel to be supplied to the engine. Here, the fuel may be a known engine fuel such as gasoline, diesel, or LPG. Referring to FIG. 1 showing the hybrid system, in a case where the electrified vehicle according to the exemplary embodiment of the present disclosure is a hybrid electric vehicle, the electric generator includes the engine 1 that generates and provides rotational power as described above, and a motor that receives the rotational power of the engine 1 and operates as a generator.

Here, since the motor may be at least one of the drive motor 3 or the HSG 6, and the HSG 6 is a motor directly connected to the engine 1 to enable constant power transmission, the HSG 6 may be operated as a generator using the rotational power of the engine 1 to charge the battery which is the energy storage system 8, or the HSG 6 and the drive motor 3 may be simultaneously operated as a generator using the rotational power of the engine 1 to charge the battery which is the energy storage system 8.

Furthermore, any other motor which is configured to receive the engine's rotational power and is mounted in the vehicle to generate power using the engine's rotational power to charge the battery may be used as a component of the electric generator for the stay mode together with the engine.

When charging the battery using the HSG 6, the engine clutch 2 is opened so that the rotational power of the engine 1 is not transmitted to the drive motor 3, and when using the drive motor 3 for battery charging, the engine clutch 2 is closed, and the transmission 4 is controlled to block power transmission to the output shaft, that is, to enter the neutral (N) state.

In a case where the electrified vehicle according to the exemplary embodiment of the present disclosure is a fuel cell vehicle (FCEV), the fuel tank 9 in FIG. 1 is replaced with a hydrogen tank that stores hydrogen which is a fuel gas, and the engine 1 and the HSG 6 as the electric generator are replaced with a fuel cell stack.

The vehicle provided with the hybrid system of FIG. 1 may be driven in an electric vehicle (EV) mode, which is a pure electric vehicle mode that utilizes only the power of the motor 3, or a hybrid electric vehicle (HEV) mode that utilizes the power of the engine 1 and the power of the motor 3 in combination.

Furthermore, when braking the vehicle (when decelerating due to depression of a brake pedal) or when coasting by inertia, a regenerative mode is executed to recover vehicle kinetic energy as electrical energy through motor power generation to charge the battery. In the hybrid electric vehicle, the regenerative mode function is essential to increase vehicle efficiency and improve fuel efficiency.

Furthermore, the hybrid electric vehicle is provided with a hybrid control unit (HCU)/vehicle control unit (VCU) 21, which is a higher-level control unit which is configured to control overall vehicle operation, and is provided with a variety of other control units to control a variety of apparatuses of the vehicle.

For example, the hybrid electric vehicle may include an engine control unit (ECU) 22 that is configured to control the operation of the engine, a motor control unit (MCU) 23 that is configured to control the operation of the motor, a battery management system (BMS) 24 that collects battery state information to be used for control of battery charging/discharging or provided to another control unit and performs control to manage the energy storage system (ESS) 8, and a full-automatic temperature control unit (FATC) 25 that is configured to control the operation of an air conditioning system 50.

Furthermore, the hybrid electric vehicle may include a transmission control unit (TCU) 26 that is configured to control the operation of the transmission and an EPB control unit 27 that is configured to control braking and release of an electronic parking brake. Here, the transmission control unit 26 may perform shift control during traveling, “P” range setting and release control during stop, and the like.

The vehicle control unit 21 and the respective control units (22 to 27) perform cooperative control by exchanging information with each other through communication for vehicle power control, drive control, full automatic temperature control, shift control, braking control, “P” range setting and release control, electronic parking brake (EPB) braking and release control, power generation control, and battery charge and discharge control, in which a high-level control unit collects various information from low-level control units and transmits control commands to the low-level control units.

The control process of the exemplary embodiment of the present disclosure may be performed by the plurality of control units that perform the cooperative control, or may be performed by a single control unit that has integrated functions of the control units, instead of the plurality of control units.

That is, in the above description, an example in which the control subject is divided into a plurality of control units has been described, but instead, the control process according to the exemplary embodiment of the present disclosure may be performed by a single control element configured for performing the functions of the plurality of control units integrally.

In an exemplary embodiment of the present disclosure, either the plurality of control units or the integrated single control element described above may be referred to as a control unit, and the control process according to the exemplary embodiment to be described below may be performed by the control unit. In the following description, the “control unit 20” collectively refers to the plurality of control units and the integrated single control element described above.

As shown in FIG. 2, the control unit of the electrified vehicle according to the exemplary embodiment includes an input device 11, a driving information detector 12, an information output device 30, and a navigation device 40. The input device 11 is used when a user (hereinafter, including a driver) wishes to input necessary information to perform the control process According to the exemplary embodiment of the present disclosure, including a stay mode control process.

For example, a vehicle user such as a driver may set the stay mode to ON or OFF by manipulating the input device 11, and may select one of four ways to use the stay mode as described later.

The input device 11 is electrically connected to the control unit 20. That is, the input device 11 is connected to the control unit 20 to enable input of electrical signals. Any device that enables user's operation and selection or input of information, such as a switch, a button, or a touchscreen, may be employed as the input device 11 in an exemplary embodiment of the present disclosure.

Furthermore, the input device 11 may be an audio, video and navigation (AVN) or Audio, Video, Navigation, and Telematics (AVNT) input device, and may include an AVN or AVNT touchscreen.

Furthermore, the input device 11 may include a mobile device configured for executing a stay mode-related application. The mobile device must be communicatively connected to the control unit 20 in the vehicle. For the present purpose, an input/output communication interface is used for communication between the mobile device and the control unit 20.

Accordingly, in a case where an electrical signal according to the operation of the input device 11 is input to the control unit 20, the control unit 20 may recognize ON or OFF of the stay mode selected by the user, and may perform control for entering and executing the stay mode using a selected stay mode usage method.

Furthermore, the vehicle user may reserve ON of the stay mode through the input device 11, which may be performed by setting a schedule (day of the week and time slot) for ON of the stay mode through the input device 11.

Furthermore, the driving information detector 12 is a device which is configured to detect relevant information necessary for performing the control process according to the exemplary embodiment of the present disclosure, including the stay mode control process, and the control unit 20 may obtain the relevant information necessary for performing the control process according to the exemplary embodiment of the present disclosure, from a signal of the driving information detector 12.

In an exemplary embodiment of the present disclosure, the driving information detector 12 may include a gear range detector which is configured to detect a gear range, a power detector which is configured to detect on or off, and an ACC power state of a vehicle power source, and a door opening/closing detector which is configured to detect opening and closing of a vehicle door.

Here, the gear range detector may be a sensor which is configured to detect an input of a gear range when a driver operates an operating mechanism to select or change the gear range in the typical electronic transmission system (SBW).

As a detection example, in a case where the sensor detects a “P” range input state through the operating mechanism and outputs the result as an electrical signal, the signal may be input to control units such as the transmission control unit (TCU) 26 and the vehicle control unit (VCU, HCU) 21.

Furthermore, the power detector may be a device that outputs an electrical signal according to the driver's ON, OFF and Accessory (ACC) operations, which may be a button starter that outputs an electrical signal according to a Start/Stop Switch Button (SSB) operation.

Furthermore, in the typical vehicle, the driving information detector 12 is used to detect vehicle driving information, and includes an accelerator position sensor (APS) which is configured to detect a driver's accelerator position value and a brake pedal position sensor (BPS) which is configured to detect a driver's brake pedal position value, a motor speed sensor which is configured to detect the motor speed, a vehicle speed sensor which is configured to detect the vehicle speed, and the like. Here, the vehicle speed sensor may be a wheel speed sensor, and vehicle speed information may be obtained from signals of the wheel speed sensor in a known manner.

The information output device 30 is a device that outputs various information to be provided to the user during the control process according to the exemplary embodiment of the present disclosure, including the stay mode. The information output device 30 may include a display device that displays information, and further include a sound output device that outputs the information as sound.

Here, the display device may include a cluster, or a display device of the navigation device 40. In a case where the cluster is used as the display device, a cluster control unit is involved in the control process of the exemplary embodiment as a control subject that performs communication and cooperative control with other control units.

The navigation device 40 is electrically connected to the control unit 20 to enable signal input and output, and is configured to perform a normal navigation function. That is, in a case where a driver inputs and sets a destination in the navigation device 40, the navigation device 40 searches and generates driving routes to the destination, and is configured to determine an estimated driving distance, an estimated driving time, and an estimated arrival time for each driving route.

Accordingly, the navigation device 40 displays various navigation information, including a driving route on a map selected by the driver, a speed limit on a driving road, the remaining driving distance and driving time to the destination, and an estimated arrival time, through the display device, and provides the information to the driver. Furthermore, in a case where the vehicle arrives at the destination, the navigation device 40 transmits destination arrival information indicating that the vehicle has arrived at the destination to the control unit 20.

The input device 11, the information output device 30, and the navigation device 40 are electrically connected to the control unit 20 to input electric signals to the control unit 20 or receive electric signals from the control unit 20 as described above, which are shown as separate components in FIG. 2.

However, in an exemplary embodiment of the present disclosure, the input device 11, the information output device 30, and the navigation device 40 may be replaced with an AVN or AVNT system which is already provided in the vehicle and can perform their functions integrally. Here, a control unit of the AVN or AVNT system is involved in the control process of the exemplary embodiment as a control subject that performs communication and cooperative control with other control units.

Hereinafter, the control process according to the exemplary embodiment will be described.

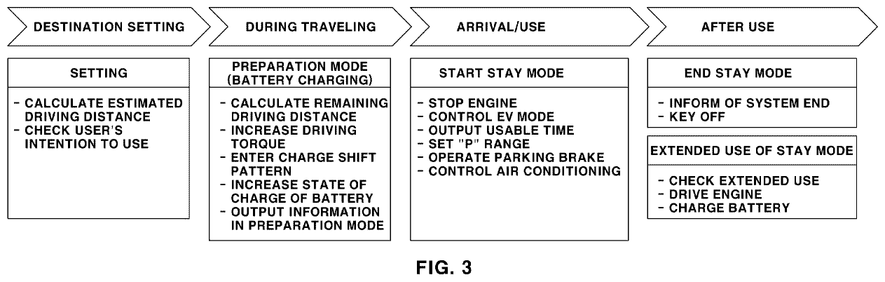

FIG. 3 is a diagram schematically showing a control process according to an exemplary embodiment of the present disclosure.

First, in an exemplary embodiment of the present disclosure, in a case where a vehicle user such as a driver or other passengers is willing to stay in a vehicle for a predetermined stay time after arriving at a destination, when setting the destination in the navigation device 40, the vehicle user inputs and sets the intention to stay during the stay time through the navigation device 40 or the input device 11.

For example, in a case where the driver has to travel 40 km to work by vehicle, the driver may leave an hour earlier than a normal departure time to avoid rush hour traffic, arrive at a company parking lot earlier than a designated commute time, and then prepare for work or rest in the vehicle.

To the present end, the driver inputs and sets the destination in the navigation device 40, and inputs and sets the intention to stay in the vehicle through the navigation device 40 or the input device 11. Accordingly, the navigation device 40 searches for and generates driving routes to the destination, and is configured to determine an estimated driving distance, an estimated driving time, and an estimated arrival time for each driving route.

While the vehicle is moving to the destination, the navigation device 40 displays a variety of navigation information such as a driving route on a map selected by the driver, a speed limit of a driving road, the remaining driving distance and driving time to the destination, and an estimated arrival time through a display device, and transmits the navigation information to the control unit 20.

Furthermore, while the vehicle is moving to the destination, the control unit 20 is configured to control the operation of a vehicle system based on the destination, the driving route, the remaining driving distance and driving time, the estimated arrival time, the stay intention and stay time at the destination. Accordingly, the control unit 20 is configured to control a state of charge (SOC) value of the energy storage system (ESS, high-voltage battery), a latent heat capacity of the engine, and the like.

Here, the vehicle system includes the drive system that drives the vehicle, the electric generator, the transmission 4, and the air conditioning system 50. The control unit 20 is configured to perform control so that the driving route to the destination may be guided through the navigation device 40 while the vehicle is moving. Furthermore, the control unit 20 may be configured for controlling the operation of the electric generator to control the state of charge of the battery, the latent heat capacity of the engine, and the like.

While the vehicle is moving in the present way, the control unit 20, the engine control unit 22 among the plurality of control units 20 for cooperative control, may increase torque of the engine as the electric generator to charge the battery when the stay mode is reserved.

Furthermore, the transmission control unit 26 may enter a predetermined charge shift pattern and perform shift control according to the charge shift pattern. Furthermore, the vehicle control unit 21 (HCU, VCU) may increase the state of charge of the battery, and may be configured for controlling the operation of the information output device 30 to output relevant information during control of a preparation mode to be described later.

Accordingly, in a case where the vehicle arrives at the destination, the navigation device 40 transmits destination arrival information informing of arrival at the destination to the control unit 20. Subsequently, in a case where the driver inputs “P”, which is the parking range, and selects the ACC power, the control unit 20 may enter the stay mode. Here, the EPB control unit 27 of the control unit 20 switches to “P” according to the driver's “P” input, and then is configured to control the operation of a parking brake to maintain the “P” state.

After entering the stay mode, the control unit 20 is configured to control the display device of the information output device 30 to display an estimated use time of the stay mode. In the stay mode, the control unit 20 is configured to control the operation of the air conditioning system 50 to maintain the vehicle interior in a comfortable state.

Furthermore, the control unit 20 is configured to perform control so that power from the energy storage system (ESS, battery) may be supplied to a vehicle's outlet, so that the vehicle user can use electric apparatuses in the vehicle by connecting the electric apparatuses to the outlet.

Furthermore, the control unit 20 may be configured for controlling the operation of the vehicle system including the electric generator and the charging device (power converter such as an inverter) in consideration of the vehicle user's purpose of staying in the vehicle after entering the stay mode. Here, in a case where it is necessary to secure thermal energy or electrical energy through engine driving, the control unit 20 may be configured for controlling the operation of the vehicle system such as the engine after confirming the intention of the vehicle user.

In a case where there is no intention to use thermal energy or electrical energy for a certain time period, the vehicle system may be controlled separately. Furthermore, when power generation is unnecessary in the stay mode, the engine control unit 20 maintains the engine in a stopped state, and the vehicle control unit (HCU, VCU) 21 is configured to control the vehicle in an EV mode (in which the engine is not operated).

Furthermore, when the stay mode ends after use of the stay mode, the control unit 20 may be configured for controlling the operation of the information output device 30 to display a message informing of the end of the stay mode, and accordingly, key-off may be performed by the driver or the control unit 20.

Furthermore, the control unit 20 may display a message for confirming whether to extend the use of the stay mode after using the stay mode through the information output device 30 so that the vehicle user can check and determine whether to extend the use of the stay mode.

Here, in a case where the vehicle user determines and selects to extend the use of the stay mode, the control unit 20 is configured to control the operation of the electric generator and the charging device to charge the energy storage system (ESS, battery) to thereby prepare for the subsequent use of power in the stay mode.

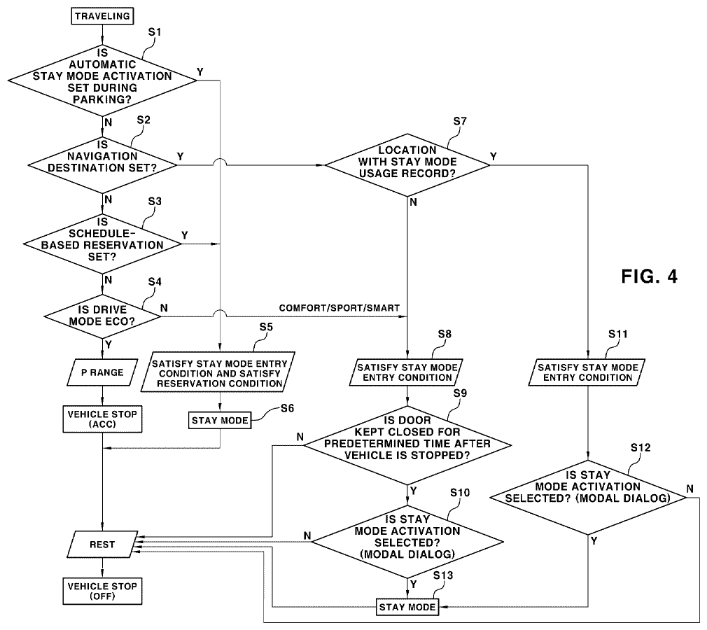

FIG. 4 is a flowchart showing the control process according to an exemplary embodiment of the present disclosure, which shows several examples of how to use the stay mode and how to enter the stay mode. In FIG. 4, situations in which the stay mode is used are classified into four types.

In an exemplary embodiment of the present disclosure, the vehicle user may select one of the following four stay mode usage methods, which may be performed through a stay mode setting process using the input device 11, or the like.

In an exemplary embodiment of the present disclosure, when the vehicle user sets or selects the stay mode usage method, the control unit 20 may be configured for controlling ready, entry, start, use, and end of the stay mode using the stay mode usage method set or selected by the vehicle user.

First, in an exemplary embodiment of the present disclosure, the stay mode usage method may include a method of automatically activating the stay mode during parking, in which the stay mode is automatically started and activated during parking. In a case where the automatic stay mode activation during parking is selected and set (S1), the vehicle state satisfies a predetermined stay mode entry condition in a state in which the vehicle arrives at a certain location and is stopped (S5), the control unit 20 may set the stay mode to be activated (S6).

Here, the predetermined stay mode entry condition may include a condition in which the vehicle gear range is “P” (parking) and the vehicle power is an ACC power state. That is, in a case where the vehicle is stopped and enters the “P” range and the ACC power state, the control unit 20 automatically executes the stay mode (ON) (S6).

Alternatively, although not shown in the drawing, in a case where the predetermined stay mode entry condition is satisfied and the vehicle user separately executes the stay mode (ON) through the input device 11, the control unit 20 may set the stay mode to be activated. Here, the stay mode activation state is a state in which the stay mode is set to ON and is executed.

In an exemplary embodiment of the present disclosure, the stay mode usage method may further include a schedule-based stay mode usage method. This is a method in which the control unit 20 activates the stay mode according to reservation setting information, in a case where the destination is set in the navigation device (S2) and the stay mode is set to a reservation in a state in which the automatic stay mode activation during parking is not set (S1).

In the present method, the control unit 20 first is configured to determine that the stay mode is in the schedule-based reservation setting state (S3). Accordingly, in a case where a current time and a current vehicle location match the reservation setting information, that is, in a case where the current time and vehicle location meet a reservation schedule and a reservation location on the day of the week and the time slot preset by the vehicle user (S5), the control unit 20 may set the stay mode to be activated (S6).

Here, the reservation location refers to a location preset by the driver, which is unrelated to the destination set in the navigation device 40. However, the current vehicle location may be information transmitted from the navigation device.

In the instant case, in a case where the vehicle state satisfies the set stay mode entry condition, for example, the condition that the gear range is the “P” state and the vehicle power is the ACC power state (S5), the stay mode may be set to ON to be executed (S6).

Furthermore, in a case where the vehicle has arrived at the reservation location according to the reservation schedule (day and time) and the vehicle user additionally sets the stay mode to ON through the input device 11, the stay mode may be set to ON to be executed.

In an exemplary embodiment of the present disclosure, the stay mode usage method may further include a navigation-linked stay mode usage method. This is a method of setting the stay mode reservation so that the stay mode is to be activated in a case where the destination is set in the navigation device 40 (S2) and the vehicle arrives at the destination set in the navigation device 40 in a state in which the automatic stay mode activation during parking is not set (S1). Here, the control unit 20 may set the stay mode to be activated in a case where the predetermined condition is satisfied after the vehicle arrives at the destination.

In the instant case, after the vehicle arrives at the destination, the navigation device 40 outputs destination arrival information indicating that the vehicle has arrived at the destination. The control unit 20 receives the destination arrival information, checks whether the predetermined stay mode entry condition is satisfied (S11). In a case where the predetermined stay mode entry condition is satisfied, the stay mode is automatically entered even without separate driver's operation (stay mode is ON). Here, the predetermined stay mode entry condition may include a condition in which the vehicle gear range is “P” (parking) and the vehicle power is an ACC power state.

Alternatively, in a state in which the predetermined stay mode entry condition is satisfied after the vehicle arrived at the destination, in a case where the vehicle user additionally turns on the stay mode through the input device 11, the control unit 20 may set the stay mode to be activated. The stay mode activation state is a state in which the stay mode is turned on and executed.

Alternatively, in a state in which the current location where the vehicle has arrived is the same as the destination set in the navigation device 40, the control unit 20 checks whether the current vehicle location is a location with a previous stay mode usage record (S7). In a case where the current vehicle location is the location with the previous stay mode usage record and the above-described stay mode entry condition is satisfied (S11), the control unit 20 may recommend the stay mode activation to the driver (S12).

Here, the process of recommending the stay mode activation includes a process of controlling the operation of the information output device 30 to display a message inducing stay mode activation as a modal dialog. In the present process, in a case where the driver checks the content of the modal dialog and then turns on the stay mode through the input device 11, etc. according to the guidance of the modal dialog, the stay mode is activated (S13).

For example, assuming that the driver utilizes a camping site, in a case where the vehicle arrives at the camping site set as the destination, and in a case where the camping site is a location with a previous stay mode usage record, the stay mode activation may be recommended to the driver.

In the instant case, before the vehicle arrives at the destination, in a case where the destination is a location with a stay mode usage record more than a preset number of times (for example, 10 times), when the vehicle enters an area within a preset distance (for example, 2 km) from the destination, the control unit 20 may be configured for controlling the vehicle system in preparation for entering the stay mode when the vehicle is stopped (this may be the preparation mode control to be described later).

In an exemplary embodiment of the present disclosure, the stay mode usage method may further include a stop-based stay mode recommendation method. In the present method, in a state in which the automatic stay mode activation during parking is not set (S1), in a case where the destination is set in the navigation device 40 (S2), and in a case where the vehicle arrived at the destination preset in the navigation device 40 and the location at which the vehicle arrived is a location with no previous stay mode usage record (S7), the control unit 20 checks whether the above-described stay mode entry condition is satisfied (S8). In a case where the predetermined stay mode entry condition is satisfied, the control unit 20 checks whether the vehicle door is kept closed (is not opened) for a predetermined time period (for example, 30 seconds) after the vehicle is stopped (S9).

In a case where the closed state is maintained for the predetermined time period, the stay mode activation is recommended to the driver (S10). Here, the control unit 20 is configured to control the operation of the information output device 30 to display a message inducing stay mode activation in a modal dialog form. After the driver checks the content of the message in the modal dialog form, the driver turns on the stay mode through the input device 11 according to guidance of the modal dialog to activate the stay mode (S13).

Furthermore, in an exemplary embodiment of the present disclosure, in a state in which the automatic stay mode activation during parking is not set (S1), in a case where the destination is not set in the navigation device 40 (S2) and the schedule-based reservation is not set (S3), whether to turn on and enter the stay mode may be determined depending on the vehicle's drive mode. For example, in a case where the vehicle's drive mode is set to an Economical mode (S4), the stay mode may not be activated.

On the other hand, in a case where the vehicle's drive mode is set to a mode other than the Economical mode, for example, a comfort mode, a sports mode, or a smart mode, the control unit 20 may set the stay mode to be activated when the predetermined stay mode entry condition is satisfied (S8). The comfort mode is the most common driving mode, also typically refers to a normal mode. The comfort mode is a driving mode that provides a user with a smooth driving and comfortable riding experience. The economical mode is a driving mode for improving fuel efficiency, and is a driving mode configured for improving fuel efficiency by controlling an engine and transmission of the vehicle. The economical mode may suppress a driving that deteriorates fuel efficiency, such as rapid acceleration compared to the comfort mode. The economical mode refers to the driving mode that controls the vehicle to minimize fuel consumption due to unnecessary acceleration by controlling the output and shift time of the vehicle. The sports mode is a driving mode for providing a more dynamic and sporty driving environment to a driver. In the sports mode, a steering wheel, a suspension, an engine, and a transmission may be appropriately controlled for dynamic and sporty driving. For example, when the user changes the driving mode to the sports mode, settings of the steering wheel and the suspension may become firmer or heavier. The smart mode refers to the driving mode that controls the vehicle based on the identified driver's driving pattern or habits.

Alternatively, in a state in which the vehicle's drive mode is set to the mode other than the Economical mode, such as the comfort mode, sports mode or smart mode, in a case where the predetermined stay mode entry condition is satisfied (S8) and the vehicle door is not opened and remains closed for a preset time (for example, 30 seconds) after the vehicle is stopped (S9), the stay mode activation is recommended to the driver (S10).

Here, the control unit 20 is configured to control the operation of the information output device 30 to display a message inducing the stay mode activation in a modal dialog form. After the driver checks the content of the message in the modal dialog form, the driver turns on the stay mode through the input device 11 according to guidance of the modal dialog to activate the stay mode (S13).

Furthermore, in an exemplary embodiment of the present disclosure, a cluster in front of a driver's seat and an AVN (or AVNT) display device may be selectively used as the display device of the information output device 30, and information such as the stay mode state, battery state, battery usage, and remaining amount (displayable in time) may be displayed at all times.

Furthermore, an AVN (or AVNT) or mobile device including both an input device and a display device may be used to select and input ON and OFF of the stay mode, and the AVN (or AVNT) or mobile device may be used to newly input or change setting values related to the stay mode (for example, schedule setting values for reservation setting).

Furthermore, in an exemplary embodiment of the present disclosure, schedule notifications related to the stay mode, the remaining time until charging, stay mode activation induction/recommendation notifications (modal dialog messages), stay mode switching selection notifications, etc. may be displayed using the display device, and the schedule reservation settings in the schedule-based stay mode usage method may be performed using the input device.

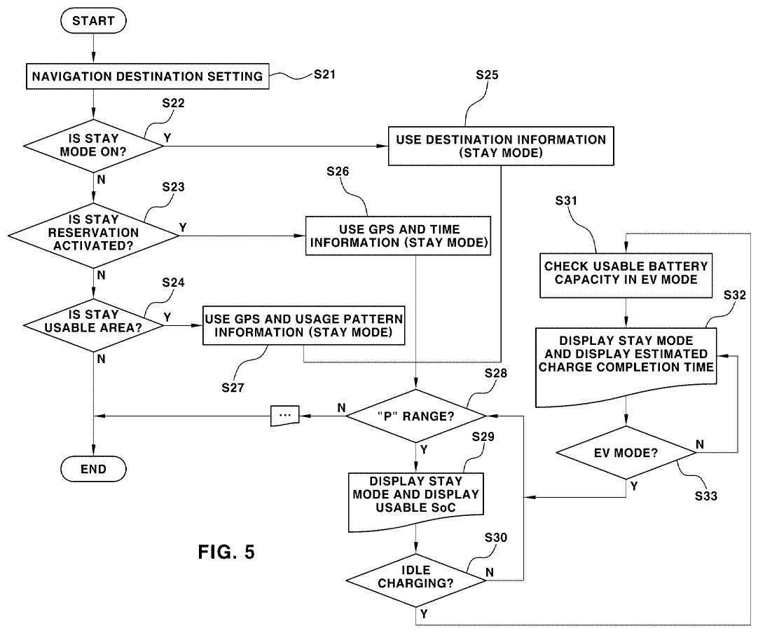

FIG. 5 is a flowchart showing a stay mode entry and control process according to an exemplary embodiment of the present disclosure. As shown in FIG. 5, after the destination is set in the navigation device 40 (S21), in a state in which the stay mode ON is selected and input (S22), in a case where a determination is made that the vehicle has arrived at the destination based on the navigation information received from the navigation device 40 (S25), the control unit 20 is configured to determine whether the stay mode entry condition, that is, the condition in which the vehicle gear range is “P” and the vehicle power is the ACC power state, is satisfied (S28).

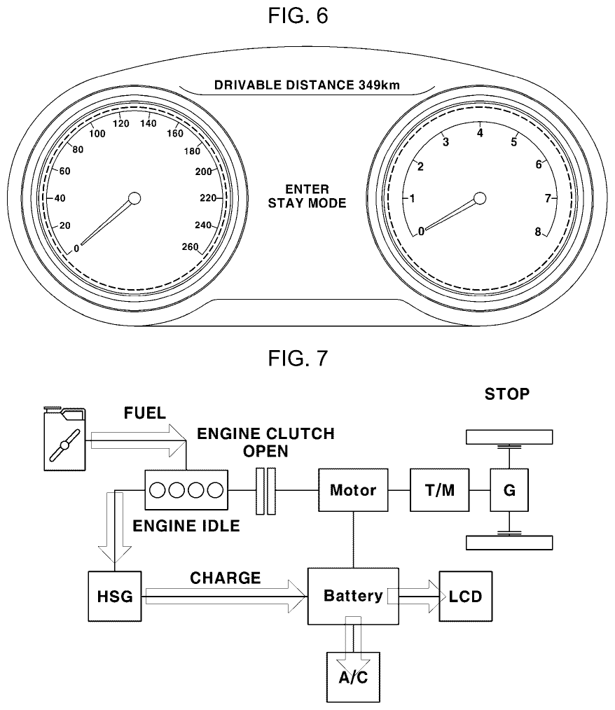

Here, in a case where the predetermined stay mode entry condition is satisfied, the control unit 20 outputs the vehicle entry into the stay mode through the information output device 30 (for example, AVN display device), and is configured to perform control so that the vehicle enters the stay mode. FIG. 6 is a diagram showing a message display screen for guiding entry into a stay mode according to an exemplary embodiment of the present disclosure.

After entering the stay mode, the control unit 20 is configured to perform the operation of the information output device 30 to display the stay mode state and display battery-related information such as a usable battery capacity (that is, a usable SoC) (S29).

Furthermore, in the stay mode state, in a case where battery charging is necessary, the control unit 20 is configured to perform control for idle charging to drive the engine in an idle state and simultaneously generate power using rotational power of the engine to charge the battery (S30). In an exemplary embodiment of the present disclosure, idle charging may refer to an operation of the vehicle system to secure vehicle energy in the stay mode entry state.

Although not illustrated in the drawing, according to the exemplary embodiment of the present disclosure, in the stay mode entry state, in a case where it is necessary to secure vehicle energy including electrical energy, the control unit 20 may confirm the vehicle user's intention to use additional energy, and may be configured for controlling the vehicle systems such as the electric generator to secure vehicle energy according to the vehicle user's intention to use additional energy.

Here, the case where it is necessary to secure the vehicle energy may be set to a case where the usable battery capacity (usable SoC or electricity usable time in hours) in the EV mode (engine not driven) after entering the stay mode becomes lower than a preset value, by the control unit 20.

Furthermore, the process of checking the vehicle user's intention to use additional energy by the control unit 20 may be performed by controlling the display device of the information output device 30 to display a message for confirming whether to use additional energy, and checking, in a case where the vehicle user inputs the intention to use additional energy through the input device 11, the intention by the control unit 20.

FIG. 7 shows an idle charge state in which a Hybrid Starter Generator (HSG) is operated with rotational power of an engine to charge a battery through an inverter according to an exemplary embodiment of the present disclosure. As shown in FIG. 7, during the idle charging, the engine clutch 2 is opened to operate the HSG 6 with the rotational power of the engine 1 to thereby charge the battery 8.

Alternatively, the engine clutch 2 is kept closed and the transmission 4 is set to neutral (N) to operate the motor 3 with the rotational power of the engine 1 to thereby charge the battery 8.

Furthermore, as shown in FIG. 5, during the idle charging in the stay mode entry state, the control unit 20 checks the usable battery capacity (usable SoC) in the EV mode (S31), and is configured to determine an estimated charging completion time based on the checked SoC. Accordingly, the control unit 20 displays the stay mode and the determined estimated charging completion time through the information output device 30 (S32).

In an exemplary embodiment of the present disclosure, the EV mode after entering the stay mode is a mode in which vehicle power is used through battery discharge without engine driving. Unlike the idle charging in which the engine is driven in an idle state and the battery is charged through the HSG and the inverter, the EV mode may be defined as a mode in which the vehicle operates and utilizes electric apparatuses with battery charging power without driving the engine.

FIG. 5 shows a schedule-based stay mode usage method in which, when the stay mode is set to a reservation, the entry into the stay mode is performed according to reservation setting information.

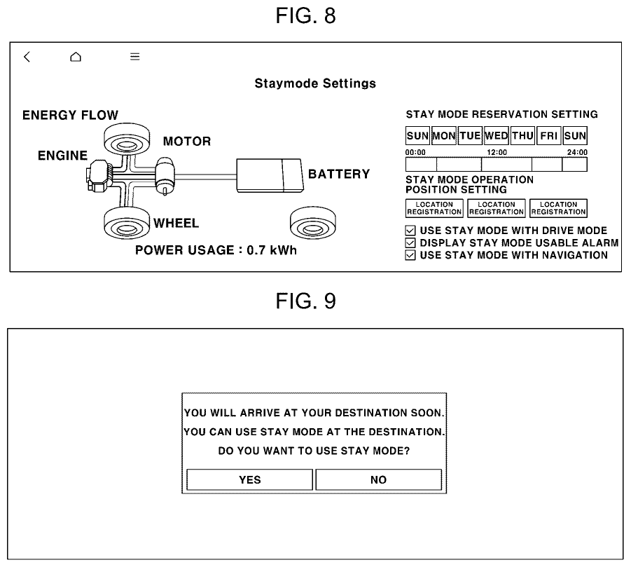

FIG. 8 shows a stay mode setting screen according to an exemplary embodiment of the present disclosure, in which a stay mode setting menu is provided through a touchscreen of AVN (or AVNT), which is an integrated display device of the input device 11 and the information output device 30.

As shown in FIG. 8, the stay mode setting menu includes a stay mode reservation setting menu. In the stay mode reservation setting menu, a reservation schedule may be set according to the day and a time slot for using the stay mode, and a reservation location, which is a stay mode operation location, may be registered.

In the present way, in a state in which the stay mode is set to the reservation, in a case where a reservation condition, that is, a current time and a current vehicle location satisfy the preset reservation schedule (day of the week and time slot) and the reservation location (see S26), and the predetermined stay mode entry condition (“P” range, the ACC power state, and the like) is satisfied (see S28), the stay mode may be entered.

Here, the stay mode may be entered in a case where the condition that the stay mode ON is selected and input by the driver is further satisfied, or the stay mode may be entered regardless of the condition that the stay mode ON is selected and input by the driver.

In FIG. 5, in a state in which the destination is set in the navigation device 40 (S21), in a case where the vehicle has arrived at a location close to the destination using Global Positioning System (GPS) information (for example, an area within a preset distance from the destination), the stay mode activation may be induced and recommended using a modal dialog (see S27).

Here, the control unit 20 may be configured for controlling the operation of the information output device 30 to display a modal dialog asking whether to use the stay mode after arriving at the destination. FIG. 9 shows a modal dialog for asking whether to use the stay mode in an exemplary embodiment of the present disclosure.

In a case where the vehicle user selects the use of the stay mode in the modal dialog, the control unit 20 is configured to determine whether the vehicle state satisfies the predetermined stay mode entry condition when the vehicle arrives at the destination (S28), and when satisfied, the stay mode is entered.

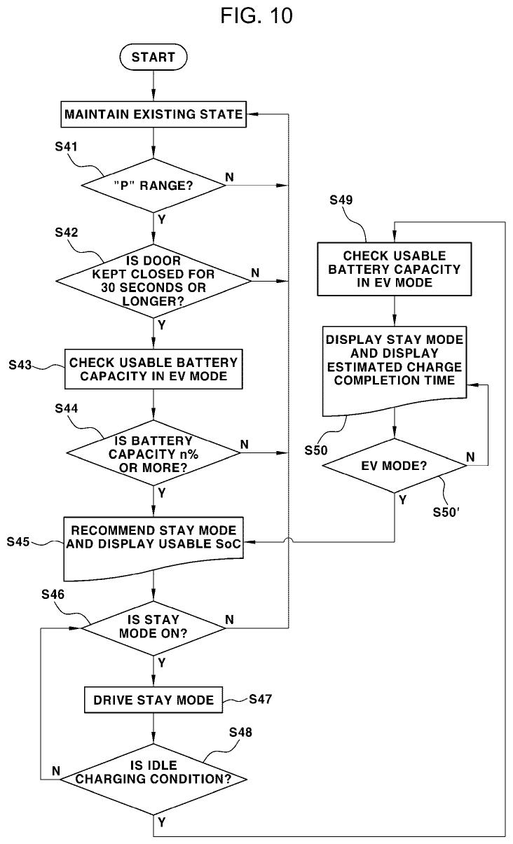

FIG. 10 is a flowchart showing an example in which the vehicle user determines whether to use the stay mode using display information provided through the information output device according to the exemplary embodiment of the present disclosure.

As shown in FIG. 10, in a case where the stay mode entry condition, that is, the “P” range condition and the ACC power condition, is satisfied (S41), and the vehicle door is kept closed for a preset time (for example, 30 seconds) (S42), the control unit 20 checks a usable battery capacity (usable SoC) in the EV mode (S43).

Accordingly, in a case where the usable battery capacity (usable SoC) in the EV mode is greater than or equal to a preset value (n %) (S44), the control unit 20 induces and recommends the stay mode activation using a modal dialog, and is configured to control the information output device 30 to display the usable battery capacity (usable SoC) (S45).

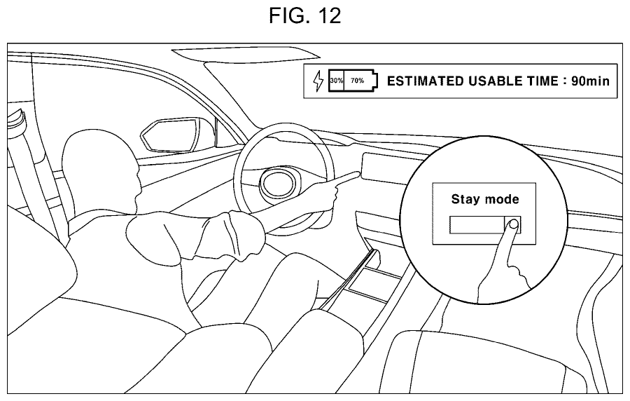

In an exemplary embodiment of the present disclosure, the usable battery capacity, that is, the remaining battery capacity information, may be displayed in a form of SoC (%), but instead, may be displayed as time information such as an estimated usable time (min) (see FIG. 12).

Accordingly, in a case where the vehicle user selects and inputs ON of the stay mode (S46), the control unit 20 is configured to control the entry and execution of the stay mode (S47). Here, the control unit may display a message for guiding the entry into the stay mode through the information output device 30, as shown in FIG. 6.

Accordingly, during the stay mode, the control unit 20 is configured to determine whether the idle charging condition determined based on the usable battery capacity (usable SoC) in the EV mode is satisfied, and in a case where the idle charging condition is satisfied (see S48), the control unit 20 is configured to perform idle charging control for driving the engine in an idle state and charging the battery with engine power (see FIG. 7).

Accordingly, during the idle charging, the control unit 20 checks the usable battery capacity (usable SoC) in the EV mode (S49), and is configured to determine the estimated charging completion time based on the check result. Furthermore, the control unit 20 displays the stay mode state and the estimated charging completion time through the information output device 30 (S50).

Thereafter, depending on the estimated charging completion time or the usable battery capacity (usable SoC) in the EV mode, the control unit 20 may perform transition from the idle charging mode to the EV mode (see S50′), and accordingly, may perform, in a case where the idle charging conditions is satisfied, the idle charging again (see S48).

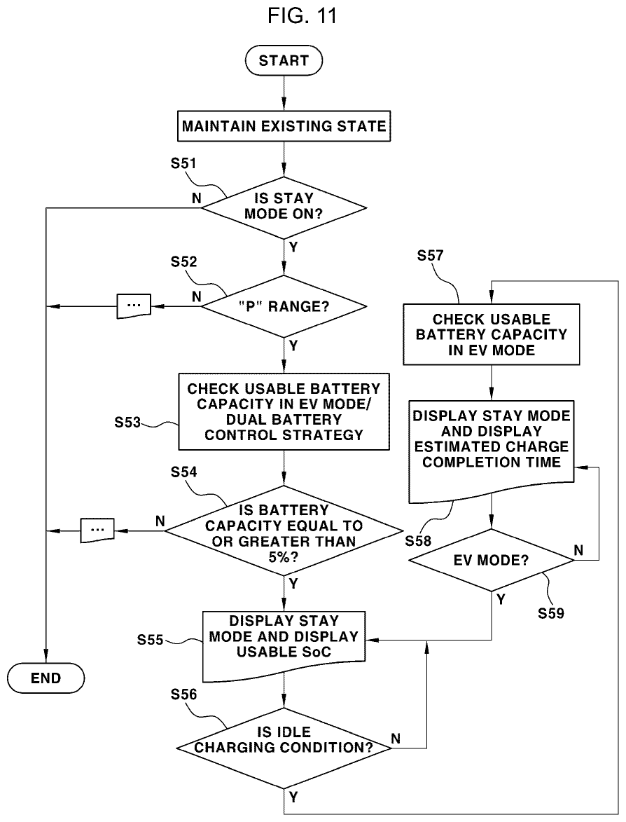

FIG. 11 is a flowchart showing another example of stay mode entry, idle charging, and EV mode execution according to an exemplary embodiment of the present disclosure, and FIG. 12 is a diagram showing a state in which a driver sets the stay mode to ON through the input device (11, touchscreen of AVNT) according to an exemplary embodiment of the present disclosure.

As shown in the drawings, in a case where the driver sets the stay mode to ON through the input device 11 (S51), the control unit 20 is configured to determine whether the stay mode entry condition, that is, the “P” range state and the ACC power state, is satisfied (S52).

Here, even if the driver turns on the stay mode, in a case where the predetermined stay mode entry condition is not satisfied (for example, not in the “P” range), the control unit 20 ends all the control processes related to the stay mode.

On the other hand, in a case where the predetermined stay mode entry condition is satisfied, the control unit 20 checks the usable battery capacity (usable SoC) in the EV mode (S53). In a case where the usable battery capacity (usable SoC) in the EV mode is smaller than a preset value (for example, 5%) (see S54), the control unit 20 ends all the control processes related to the stay mode.

However, in a case where the usable battery capacity in the EV mode is greater than or equal to the preset value (see S54), the control unit 20 displays a message indicating the stay mode entry as shown in FIG. 6 through the information output device 30, and additionally displays the usable battery capacity (usable SoC) in the EV mode through the information output device 30 (S55).

In an exemplary embodiment of the present disclosure, the usable battery

capacity, that is, the remaining battery capacity information, may be displayed in a form of SoC (%), but instead, may be displayed as time information such as an estimated usable time (min) (see FIG. 12).

Thereafter, the control unit 20 is configured to control execution of the stay mode, and is configured to determine whether the idle charging condition determined based on the usable battery capacity (usable SoC) in the EV mode is satisfied during the stay mode (S56). In a case where the idle charging condition is satisfied, the control unit 20 is configured to control the idle charging for driving the engine in an idle state and charging the battery with engine power (see FIG. 7).

Accordingly, during the idle charging, the control unit 20 checks the usable battery capacity (usable SoC) in the EV mode (S57), and is configured to determine an estimated charging completion time based on the result. Furthermore, the control unit 20 displays the stay mode state and the estimated charging completion time through the information output device 30 (S58).

Accordingly, depending on the estimated charging completion time or the usable battery capacity (usable SoC) in the EV mode, the control unit 20 may perform transition from the idle charging mode to the EV mode (see S59), and accordingly, may perform, in a case where the idle charging condition is satisfied, the idle charging again (see S56).

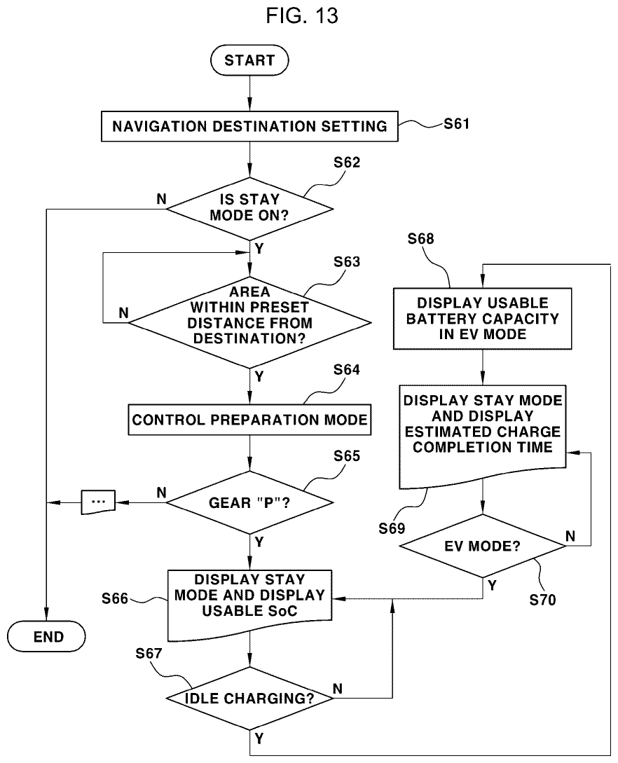

FIG. 13 is a flowchart showing the control of the vehicle system for the stay mode during traveling according to an exemplary embodiment of the present disclosure. In a state in which the destination is set through the navigation device 40 (S61), in a case where the driver turns on the stay mode through the input device 11 (S62), the control unit 20 is configured to determine whether the vehicle enters an area within a preset distance (for example, 5 km) from the destination before the vehicle arrives at the destination (S63).

Here, in a case where the vehicle enters the area within the preset distance, the control unit 20 may perform control for entering a preparation mode for preparing the stay mode in arrival at the destination while the vehicle is travelling to the destination to operate the vehicle system in the preparation mode (S64). In the preparation mode, the operation of the electric generator may be controlled to increase or control the state of charge (SOC) value of the energy storage system (ESS, high-voltage battery), a latent heat capacity of the engine, and the like.

The control unit 20 may increase torque of the engine in the electric generator to increase the amount of power generated by the electric generator, and the transmission control unit 26 may enter a charge shift pattern and perform shift control according to the charge shift pattern. Additionally, the control unit 20 may increase the state of charge of the battery, and may be configured for controlling the operation of the information output device 30 to output relevant information during control of the preparation mode.

After the vehicle arrives at the destination, the control unit 20 is configured to determine whether the stay mode entry condition, that is, the “P” range state and the ACC power state, is satisfied (S65). Here, even if the driver turns on the stay mode, in a case where the predetermined stay mode entry condition is not satisfied (for example, not in the “P” range), the control unit 20 ends all the control processes related to the stay mode.

On the other hand, in a case where the predetermined stay mode entry condition is satisfied, the control unit 20 checks the usable battery capacity (usable SoC) in the EV mode, and displays a message indicating the stay mode entry through the information output device 30, as shown in FIG. 6. Furthermore, the control unit 20 displays the usable battery capacity (usable SoC) in the EV mode through the information output device 30 (S66).

Thereafter, the control unit 20 is configured to control execution of the stay mode, and is configured to determine whether the idle charging condition determined based on the usable battery capacity (usable SoC) in the EV mode is satisfied during the stay mode (step S67). In a case where the idle charging condition is satisfied, the control unit 20 is configured to control the idle charging for driving the engine in an idle state and charging the battery with engine power (see FIG. 7).

Accordingly, during the idle charging, the control unit 20 checks the usable battery capacity (usable SoC) in the EV mode (step S68), and is configured to determine an estimated charging completion time based on the result thereof. Furthermore, the control unit 20 displays the stay mode state and the estimated charging completion time through the information output device 30 (S69).

Accordingly, depending on the estimated charging completion time or the usable battery capacity (usable SoC) in the EV mode, the control unit 20 may perform transition from the idle charging mode to the EV mode (see S70), and accordingly, may perform, in a case where the idle charging condition is satisfied, the idle charging again (see S67).

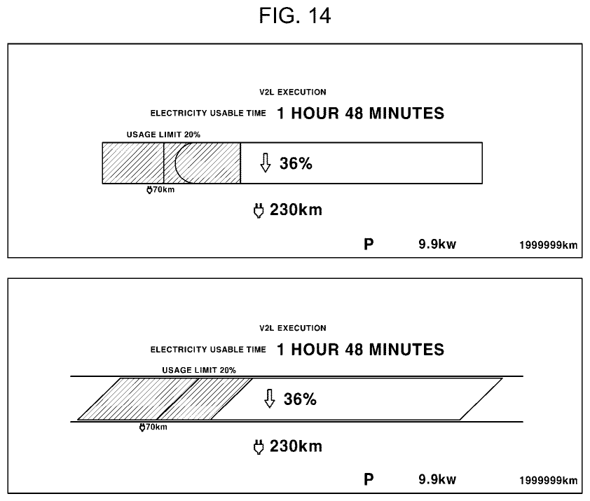

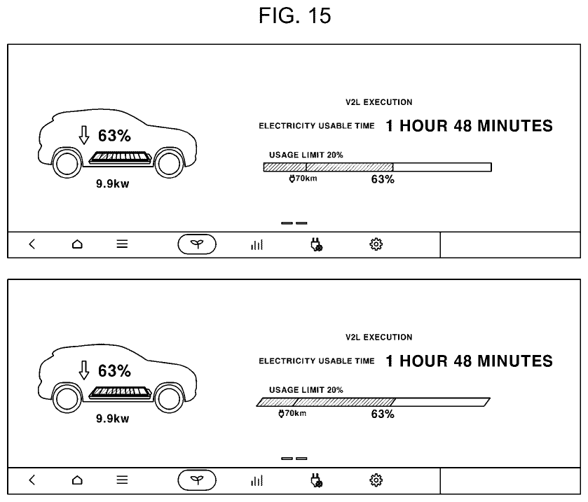

FIG. 14 is a diagram showing an example of displaying a usable battery capacity as time information (electricity usable time) on a cluster in an EV mode, and FIG. 15 is a diagram showing an example of displaying a usable battery capacity as time information on a display of an AVNT in an EV mode.

In an exemplary embodiment of the present disclosure, after determining the usable battery capacity in the EV mode, the determined usable battery capacity (remaining battery capacity) information may be displayed as information (usable SoC) in SoC (%) through a cluster or AVNT, or time information (electricity usable time).

However, in actual use, it may be more convenient to display the usable battery capacity in terms of a usable time (usable time of electrical energy stored in the energy storage system such as a battery) to confirm the actual remaining capacity in terms of battery use. Therefore, for user convenience, it is more desirable to display the usable battery capacity in the EV mode of the stay mode as time information, as shown in the examples of FIG. 14, and FIG. 15.

Accordingly, according to the electrified vehicle according to an exemplary embodiment of the present disclosure, it is possible to provide a vehicle mode (i.e., stay mode) that provides quiet and comfortable indoor roominess to a vehicle user in a parked state, allows the use of electric apparatuses without concerns about battery charging, and allows long-term stay.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electrified vehicle comprising:
an electric generator configured to generate electrical energy using vehicle fuel:
an energy storage system connected to the electric generator and configured to store the electrical energy generated by the electric generator; and
a control unit configured to control, in response that a vehicle state satisfies a predetermined stay mode entry condition in a state in which the vehicle is stopped, a vehicle system including the electric generator for entering and executing a stay mode,
wherein the stay mode is a mode in which a vehicle user can use vehicle energy including the electrical energy stored in the energy storage system in response that the vehicle user stays in the vehicle in a state in which the vehicle is parked, and
wherein the control unit is further configured to confirm, in response that securing the vehicle energy including the electrical energy in the stay mode is necessary, an intention of the vehicle user to use additional energy and to control the vehicle system for securing the vehicle energy according to the intention of the vehicle user.

2. The electrified vehicle of claim 1,
wherein the vehicle is a hybrid electric vehicle provided with an engine and a motor as a drive system thereof, and
wherein the electric generator includes the engine and a hybrid starter generator which is connected to the engine for power transmission and is configured to perform power generation using rotational power of the engine.

3. The electrified vehicle of claim 2, wherein the control of the vehicle system for securing the vehicle energy is an idle charging control for blocking the power transmission between the engine and the motor by opening an engine clutch mounted between the engine and the motor and driving the engine to charge the energy storage system with electrical energy generated by the hybrid starter generator using the rotational power of the engine.

4. The electrified vehicle of claim 1, wherein the vehicle is a hybrid electric vehicle provided with an engine and a motor as a drive system thereof, and the electric generator includes the engine and the motor that performs power generation using rotational power transmitted from the engine.

5. The electrified vehicle of claim 4, wherein the control of the vehicle system for securing the vehicle energy is performed by closing an engine clutch mounted between the engine and the motor for power transmission between the engine and the motor, controlling a transmission on a motor output side to a neutral state, and driving the engine and controlling the power generation of the motor to charge the energy storage system with the electrical energy generated by the motor using the rotational power of the engine.

6. The electrified vehicle of claim 1, wherein the vehicle is a fuel cell vehicle, and the electric generator includes a fuel cell that generates the electrical energy using fuel gas of the vehicle fuel.

7. The electrified vehicle of claim 1, wherein the predetermined stay mode entry condition includes conditions in which a vehicle gear range is P, which is a parking range, and a vehicle power is in an Accessory (ACC) power state.

8. The electrified vehicle of claim 1, wherein in response that the predetermined stay mode entry condition is satisfied and the vehicle user turns on the stay mode, the control unit is further configured to perform control for entering and executing the stay mode.

9. The electrified vehicle of claim 1, wherein the stay mode is a mode in which the electrical energy stored in the energy storage system is supplied to be usable in an air conditioning system, a vehicle infotainment system, an electric apparatus mounted in or connected to the vehicle, or an outlet in the vehicle.

10. The electrified vehicle of claim 1, further including:
a navigation device configured to set a destination of the electrified vehicle and guide a driving route of the electrified vehicle to the destination,
wherein the control unit performs, in response that the vehicle arrives at the destination set in the navigation device and the predetermined stay mode entry condition is satisfied, control for entering and executing the stay mode.

11. The electrified vehicle of claim 10, wherein the control unit performs, in response that a determination is made that the vehicle has arrived at a location within a preset distance from the set destination based on navigation information transmitted from the navigation device, control for increasing a state of charge (SOC) value of the energy storage system while the vehicle is being driven to the destination.

12. The electrified vehicle of claim 11, wherein the vehicle is a hybrid electric vehicle provided with an engine and a motor as a drive system thereof, the electric generator includes the engine and a hybrid starter generator which is connected to the engine for power transmission to start the engine and is configured to perform power generation using rotational power of the engine, and the control for increasing the state of charge of the energy storage system includes increasing torque of the engine to increase an amount of power generated by the electric generator and performing shift control according to a predetermined charge shift pattern for a transmission.

13. The electrified vehicle of claim 10, wherein in response that the vehicle arrives at the destination set in the navigation device, the control unit is further configured to check whether the destination at which the vehicle arrived is a location with a previous stay mode usage record, outputs, in response that the destination is the location with the previous stay mode usage record and the predetermined stay mode entry condition is satisfied, a message for inducing and recommending ON of the stay mode through an information output device operatively connected to the control unit, and performs, in response that the vehicle user selects ON of the stay mode according to the message, control for entering and executing the stay mode.

14. The electrified vehicle of claim 10, wherein the control unit is further configured to perform control, in response that the destination set in the navigation device is a location with a stay mode usage record more than a preset number of times, for increasing a state of charge of the energy storage system while the vehicle is travelling to the destination when the vehicle enters an area within a preset distance from the destination.

15. The electrified vehicle of claim 14, wherein the vehicle is a hybrid electric vehicle provided with an engine and a motor as a drive system thereof, the electric generator includes the engine and a hybrid starter generator which is connected to the engine for power transmission and is configured to perform power generation using rotational power of the engine, and the control for increasing the state of charge of the energy storage system is performed by increasing torque of the engine to increase an amount of power generated by the electric generator and performing shift control according to a predetermined charge shift pattern for a transmission.

16. The electrified vehicle of claim 10, wherein in response that the vehicle arrives at the destination set in the navigation device, the control unit is further configured to check whether the destination at which the vehicle arrived is a location with a previous stay mode usage record, checks, in response that the destination is a location with no previous stay mode usage record and the predetermined stay mode entry condition is satisfied, whether a vehicle door is not opened and remains closed for a predetermined time period after the vehicle is stopped, outputs, in response that the vehicle door remains closed for the predetermined time period, a message for inducing and recommending ON of the stay mode through an information output device, and performs, in response that the vehicle user selects ON of the stay mode according to the message, control for entering and executing the stay mode.

17. The electrified vehicle of claim 1, wherein the control unit is further configured to control an operation of a display device operatively connected to the control unit to display a usable time of the electrical energy stored in the energy storage system in the stay mode state.

18. The electrified vehicle of claim 1, wherein the control unit is further configured to perform control, in response that a current time and a current vehicle location match a reservation schedule and a reservation location for a day and a time slot preset by the vehicle user in a state in which the vehicle is stopped after moving, for entering and executing the stay mode in response that the predetermined stay mode entry condition is satisfied.

19. A method for controlling an electrified vehicle including an electric generator configured to generate electrical energy using vehicle fuel and an energy storage system configured to store the electrical energy generated by the electric generator; and a control unit, the method comprising:
controlling, by the control unit, in response that a vehicle state satisfies a predetermined stay mode entry condition in a state in which the vehicle is stopped, a vehicle system including the electric generator for entering and executing a stay mode,
wherein the stay mode is a mode in which a vehicle user can use vehicle energy including the electrical energy stored in the energy storage system in response that the vehicle user stays in the vehicle in a state in which the vehicle is parked, and
wherein the control unit is further configured to confirm, in response that securing the vehicle energy including the electrical energy in the stay mode is necessary, an intention of the vehicle user to use additional energy and to control the vehicle system for securing the vehicle energy according to the intention of the vehicle user.
